(19) United States
(12) Patent Application Publication
(10) Pub. No.: US 2014/0095978 A1
(43) Pub. Date: Apr. 3, 2014

(54) MASH-UP AUTHORING DEVICE USING TEMPLATES AND METHOD THEREOF

(71) Applicant: Electronics and Telecommunications Research Institute, Daejeon (KR)

(72) Inventors: Yoon Seop CHANG, Daejeon (KR); Jae Chul KIM, Daejeon (KR); Seong Ho LEE, Daejeon (KR); Young Jae LIM, Daejeon (KR)

(73) Assignee: Electronics and Telecommunications Research Institute, Daejeon (KR)

(21) Appl. No.: 14/038,398

(22) Filed: Sep. 26, 2013

(30) Foreign Application Priority Data
Sep. 28, 2012 (KR) 10-2012-0109419

(51) Int. Cl. G06F 17/22

(52) U.S. Cl. CPC G06F 17/2247
USPC 715/234

(57) ABSTRACT

There are provided a mash-up authoring device using templates and a method thereof. The mash-up authoring device that creates a mash-up using a plurality of blocks includes a template generating unit configured to generate a template including at least a first block among the plurality of blocks and provide the template by category, a mash-up authoring unit configured to provide an authoring space that allows a user to perform a mash-up authoring action of replacing the first block with a second block among the plurality of blocks, adding the second block to the template, and deleting the first block, and a block recommending unit configured to automatically recommend a third block corresponding to the first block based on parameters of the first block corresponding to the authoring action.

### CLAIM FOR PRIORITY

This application claims priority to Korean Patent Application No. 10-2012-0109419 filed on Sep. 28, 2012 in the Korean Intellectual Property Office (KIPO), the entire contents of which are hereby incorporated by reference.

### BACKGROUND

1. Technical Field

Example embodiments of the present invention relate to a mash-up authoring device, and more specifically, to a mash-up authoring device using templates and a method thereof.

2. Related Art

In general, “mash-up” refers to generating new content or services by combining and applying a variety of types of content or services. In this case, the variety of types of content or services may be configured as a program module known as a block. The mash-up refers to a web-based data integration application and can be made using a mash-up authoring tool that connects or combines blocks. As a specific example of the mash-up, there is an application in which a photo service of Flickr is combined with a map service of Google. The above mash-up allows photos associated with a location to be displayed on a map when a user clicks a specific location on the map using a mouse.

In a general mash-up work process, a mash-up developer designs what type of mash-up will be created, and searches for and selects open application interfaces (open APIs) to be used to create the designed mash-up. The mash-up developer analyzes a Google map open API and a Flickr open API, and identifies each open API service, that is, properties of blocks. In this case, the properties of the blocks may have a type of, for example, a communication protocol (code), a data format, and input and output data.

Moreover, a workflow is authored such that a selected block is used, a new block is authored, and the blocks are combined, and a user interface and a layout of an outcome screen are authored.

That is, the mash-up authoring device arranges and lists the open APIs, that is, the blocks (or widgets or components), and provides a function of connecting an input and output of each block using an input and output data format of each block. Further, the mash-up authoring device provides a function of specifying scripts or codes.

However, it is difficult to implement functions provided by a general mash-up authoring device in a mobile environment, for example, on a smart phone, a pad, and a tablet PC.

This is because many resources are required for, for example, analyzing the input and output of the blocks, and there are constraints of a mobile device due to a screen size and an input method.

In addition, general users who do not have any concept of programming have a problem in that it is difficult to check whether an input and output data format of a certain block match or can be connected, and thereby experience difficulty in authoring mash-ups.

That is, it is difficult to implement the general mash-up authoring device in the environment having the limited resources and it is difficult for the general users to conveniently use the general mash-up authoring device due to a complex method of authoring the block and the workflow.

### SUMMARY

Accordingly, example embodiments of the present invention are provided to substantially obviate one or more problems due to limitations and disadvantages of the related art.

Example embodiments of the present invention provide a mash-up authoring device with which a mash-up can be easily authored by a general user without a complex mash-up authoring process using templates that are previously provided by category.

Example embodiments of the present invention also provide a mash-up authoring method by which a mash-up can be easily authored even in a mobile environment having limited resources such that the mash-up is authored by adding, replacing, and deleting a block configuring the template.

A mash-up authoring device that creates a mash-up using a plurality of blocks includes a template generating unit configured to generate a template including at least a first block among the plurality of blocks and provide the template by category, a mash-up authoring unit configured to provide an authoring space that allows a user to perform mash-up authoring actions of replacing the first block with a second block among the plurality of blocks, adding the second block to the template, and deleting the first block, and a block recommending unit configured to automatically recommend a third block corresponding to the first block based on parameters of the first block in accordance with the authoring action.

The mash-up authoring device may further include an automatic block connecting unit configured to automatically adjust a connection between parameters of the first and second blocks in order to correct errors between the first and second blocks after the mash-up authoring action is performed.

The mash-up authoring unit may include a parameter setting unit configured to provide a function that allows the user to directly adjust at least one parameter of the first and second blocks in order to complete the mash-up.

The mash-up authoring unit may include a property setting unit configured to provide a function that allows the user to change a property of the mash-up in order to complete the mash-up.

The mash-up authoring unit may include an editing unit configured to output a template list of a selected category and provide a preview function of the template selected from the template list.

The mash-up authoring action may be performed by a drag & drop method.

The block may be defined such that an open API is configured as a program module.

In other example embodiments, a mash-up authoring method of creating a mash-up using a plurality of blocks in a mash-up authoring device includes generating a template including at least a first block among the plurality of blocks and providing the template by category, providing an authoring space that allows a user to perform mash-up authoring actions of replacing the first block with a second block among the plurality of blocks, adding the second block to the template, and deleting the first block, and automatically recommending a third block corresponding to the first block based on parameters of the first block in accordance with the authoring action.

The mash-up authoring method may further includes automatically adjusting a connection between parameters of the first and second blocks in order to correct errors between the first and second blocks after the mash-up authoring action is performed.

The providing of the authoring space may include providing a function that allows the user to directly adjust at least one parameter of the first and second blocks in order to complete the mash-up.

The providing of the authoring space may include providing a function that allows the user to change a property of the mash-up in order to complete the mash-up.

The providing of the authoring space may include outputting a template list of a selected category and providing a preview function of the template selected from the template list.

The mash-up authoring action may be performed by a drag & drop method.

The block may be defined such that an open API is configured as a program module.

In the mash-up authoring device according to the embodiment of the invention, it is possible for the general user to easily author the mash-up without a complex mash-up authoring process using the templates that are previously provided by category.

In addition, in the mash-up authoring method according to the embodiment of the invention, it is possible to easily author the mash-up even in the mobile environment having the limited resources such that the mash-up is authored by adding, replacing, and deleting of the block configuring the template.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a schematic mash-up authoring device using templates according to an embodiment of the invention.

FIG. 2 is a diagram illustrating an example of a template table provided by a template generating unit according to the embodiment of the invention.

FIG. 3 is a diagram illustrating an example of a graphic user interface provided by an editing unit according to the embodiment of the invention.

FIG. 4 is a flowchart illustrating a schematic mash-up authoring method using the templates according to the embodiment of the invention.

### DESCRIPTION OF EXAMPLE EMBODIMENTS

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings.

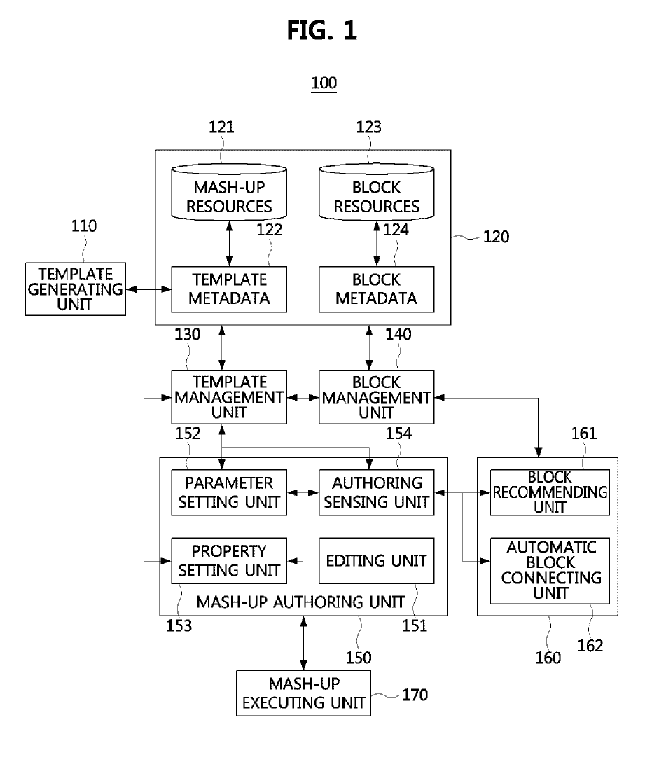

FIG. 1 is a conceptual diagram illustrating a schematic mash-up authoring device 100 using templates according to the embodiment of the invention. Hereinafter, the mash-up authoring device 100 using the templates refers to the mash-up authoring device 100 for convenience of description.

First, as illustrated in FIG. 1, the mash-up authoring device 100 according to the embodiment of the invention may include a template generating unit 110, a resource storage unit 120, a template management unit 130, a block management unit 140, a mash-up authoring unit 150, an authoring supporting unit 160, and a mash-up executing unit 170.

In this case, the template generating unit 110 generates a variety of designs of templates having different shapes and configurations, and provides the templates to a user.

More specifically, the template generating unit 110 generates a mash-up template such that the template is generated from an existing mash-up or is newly designed.

The template generating unit 110 may generate the mash-up template, for example, by category, and the mash-up template may include a block corresponding to each category.

In this case, a block can be any of a variety of content and services provided by a web service vendor in the web configured as a program module. For example, a map service from Google, a real estate information service from a real estate information site Craigslist, and a photo service from Flickr are respectively configured as the program module and thereby used as blocks. That is, a block is a module that performs a general function or a unit function provided as an open API. Meanwhile, the block may be called, for example, a component or a widget.

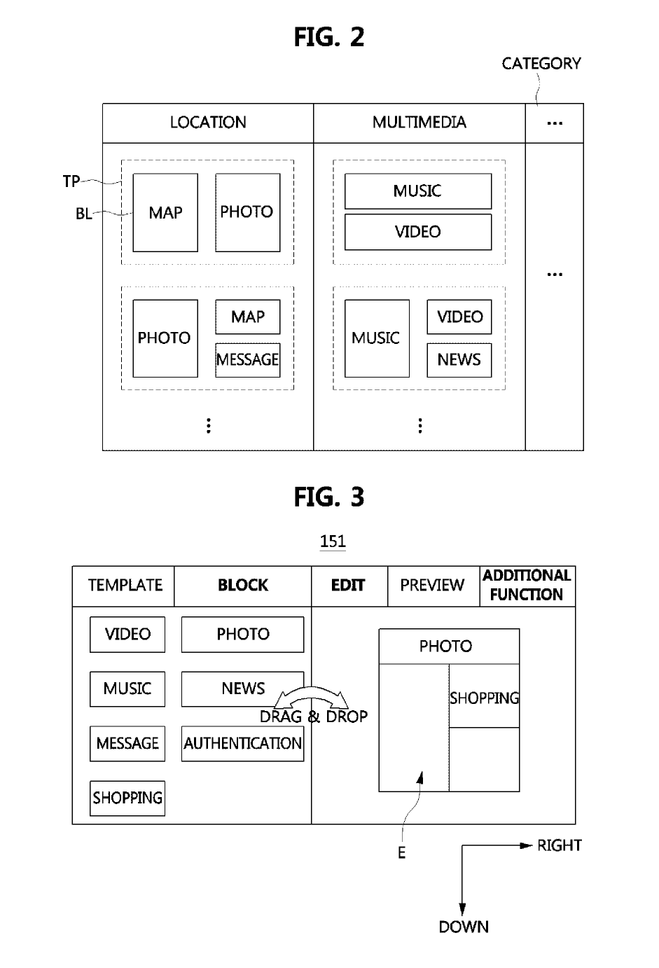

The template generating unit 110 according to the embodiment of the invention will be described in detail with reference to FIG. 2.

FIG. 2 is a diagram illustrating an example of a template table provided by the template generating unit 110 according to the embodiment of the invention.

As illustrated in FIG. 2, templates TP may be provided, for example, by category. More specifically, the templates TP may be provided by category, for example, LOCATION for indicating a location or a place and MULTIMEDIA for enjoying a video or music. In addition, although not illustrated, the categories may be variously configured as, for example, SOCIAL for providing a social network function, SEARCH for providing a search function, MESSAGE for transmitting a message, and COMPUTATION for providing a computation function.

In the LOCATION category, a template TP configured with map and photo blocks BL and a template configured with photo, map, and message blocks BL are shown. In the MULTIMEDIA category, a template TP configured with music and video blocks BL and a template configured with music, video, and news blocks BL are shown.

In this way, the template generating unit 110 according to the embodiment of the invention, for example, generates a template by category in advance and provides the template to the user, and the template is previously configured with blocks suitable for a theme of a corresponding category. Therefore, using the template having a certain block by category, it is possible for the user to omit operations of, for example, searching for and selecting the open APIs for generating the mash-up to be created, authoring a new block, authoring a workflow generated by connecting and combining the blocks, and authoring a layout (an appearance design to be displayed on a screen). Therefore, it is possible for the user to conveniently and easily author the mash-up and decrease time necessary for authoring the mash-up.

With reference to FIG. 1 again, the resource storage unit 120 stores resources of the template and the block.

More specifically, the template is stored as template metadata 122 and mash-up resources 121, and the block configuring the template is stored as block metadata 124 and block resources 123.

In general, the metadata represents secondary information in which a type of information is summarized in order to intellectually control and structurally access information. That is, the type of information of the property representing the template and the block is the metadata, and metadata may be defined as “data about data” in that it is data defining a type of data.

Here, the metadata of the template and the block may include, for example, a communication protocol and hypertext markup language (HTML) displayed in a web page.

Here, the communication protocol is used to transmit and receive data with an open API service provider, and includes, for example, JAVA Script, a representational state transfer (REST) or a simple object access protocol (SOAP). That is, the communication protocol refers to a code for performing a unit function.

The metadata of the template and the block is information used for searching for a variety of information of the template and the block, and includes input and output information of the template and the block, that is, a data format. Examples of the data format include XML, JSON, and PHP.

The template management unit 130 provides a function of querying or changing the mash-up resources 121 and the template metadata 122 of the resource storage unit 120.

The block management unit 140 provides a function of querying or changing the block resources 123 and the block metadata 124 of the resource storage unit 120.

The mash-up authoring unit 150 provides a space that allows the user to create a desired mash-up using the template that is generated in advance and provided.

For this purpose, the mash-up authoring unit 150 may include an editing unit 151, a parameter setting unit 152, a property setting unit 153, and an authoring sensing unit 154.

First, the editing unit 151 is a space for authoring a desired mash-up using the template.

More specifically, the editing unit 151 provides a graphic user interface environment in which templates and blocks are provided, and the blocks configuring the template selected by the user, for example, can be moved, added, deleted, replaced and changed.

For this purpose, the editing unit 151 may receive the template and the block from, for example, the resource storage unit 120.

In this case, when the user authors the mash-up, the graphic user interface provides a space for the user to author the mash-up and represents various templates and blocks as images that can be intuitively identified by the user.

Moreover, the editing unit 151 provides a drag & drop function of the block that allows the user to easily change the block of the template.

Meanwhile, although a case in which the mash-up is easily authored by the drag & drop function is exemplified in FIG. 1, the invention is not limited thereto, and a multi-touch method may be used rather than the drag & drop method.

Accordingly, in order for the user to author a desired mash-up, it is possible to complete the mash-up such that the block of the template having the block provided therein is replaced with another block, a new block is added to the template, and an existing block of the template is deleted without authoring a new block.

Hereinafter, the editing unit 151 according to the embodiment of the invention will be described in detail with reference to FIG. 3.

FIG. 3 is a diagram illustrating an example of the graphic user interface provided by the editing unit 151 according to the embodiment of the invention.

First, a left-side of the editing unit 151 is configured with a screen providing the template and the block.

Although not illustrated, when the user clicks a template button provided in a upper portion of the left-side screen of the editing unit 151, a variety of templates are provided by category as illustrated in FIG. 2. In this case, when the user selects one category, a template list corresponding to the selected category is output.

When one template is selected from different templates distinguished by category, the selected template is displayed on a right-side screen of the editing unit 151. In this case, a button of an upper right portion may be an editing button. For example, the selected template includes photo and shopping blocks, and an empty part (E) having no blocks.

Meanwhile, when the user wishes to preview the selected template, the user clicks a preview button provided in the upper right portion of the editing unit 151 to preview the selected template.

When the user clicks a block button provided in an upper left portion of the editing unit 151, a variety of blocks are displayed on the left-side screen of the editing unit 151. For example, blocks of videos, photos, music, news, messages, authentication, and shopping may be displayed on the left-side screen of the editing unit 151.

According to the desired mash-up, the user may replace the block included in the template, for example, the shopping block, with another block such as the video or message block.

In this case, in order to replace one block with another block, the user may use the drag & drop function provided by the editing unit 151. That is, the user may intuitively and conveniently replace the blocks using the drag & drop function provided by the editing unit 151.

Moreover, the user may add another block, for example, the news block, to the empty part (E) of the template, and also directly delete the shopping block without replacing it with another block. All these functions may be implemented by the drag & drop function.

When the preview button provided in the upper right portion of the editing unit 151 is clicked, it is possible to preview outcomes of the mash-up authored by the user.

An additional function button provided in the upper right portion of the editing unit 151 represents a function that is additionally provided to delete programming errors generated in mash-up authoring processes.

More specifically, the function represents, for example, a function of automatically recommending a block matching a block of a current template and a function of automatically changing parameters between the blocks to remove errors due to replacing, adding and deleting the block. Moreover, it is possible for the user to directly change the parameters between the blocks and change a certain property of the mash-up. Detailed descriptions of such functions will be described below with reference to descriptions of the authoring supporting unit 160.

As described above, it is possible for the user to visually recognize the template and conveniently author the mash-up by, for example, easily adding, changing, and deleting the block configuring the template using the editing unit 151 provided with the GUI.

As illustrated in FIG. 1 again, the parameter setting unit 152 provides a function that allows the user to set input and output parameters between the blocks configuring the template in order to adjust a connection between the blocks that are replaced, added, and deleted in the template.

For example, each block configuring the template has input and output parameters and the input and output parameters have respective data types. More specifically, for example, the first block may have two input parameters, and the data type of each input parameter may be an integer or float. Moreover, the first block may have one output parameter and the data type of the output parameter may be a string.

In this case, in order to remove errors in the connection between the blocks configuring the template, the user may adjust the parameter of the block. For example, it is possible to more sophisticatedly complete the connection between the blocks by changing, for example, the data type of the input and output parameter of the block to be connected.

That is, the parameter setting unit 152 provides a function that allows the user to adjust the parameter of the block in order to prevent programming errors between the blocks.

The property setting unit 153 provides a function that allows the user to change a certain property of all mash-ups in order to more sophisticatedly complete the mash-up.

Here, the mash-up refers to an application to be completed by the user through the template including the block. In this case, as described above, the property of the mash-up may refer to, for example, the communication protocol, the hypertext markup language (HTML) displayed in the web page, and the input and output parameters.

Meanwhile, the outcome of the template changed by the user in the parameter setting unit 152 and the property setting unit 153 is delivered to the template management unit 130 and is reflected.

The authoring sensing unit 154 senses authoring actions of changing, deleting, adding, and replacing the block of the template performed by the user, generates information corresponding to the authoring action, and provides the information to the authoring supporting unit 160. Hereinafter, the information corresponding to the authoring action refers to authoring information for convenience of description.

Here, the information corresponding to the authoring action may include information on, for example, a template configuration and an authoring action target block.

Moreover, the authoring sensing unit 154 receives the additional function provided by the authoring supporting unit 160 corresponding to the authoring information and provides the user with the additional function necessary for authoring the template.

In this case, the additional function may be provided in, for example, the editing unit 151. The user may be provided with the additional function to correspond the template configuration, that is, a function of recommending an appropriate block or a function of adjusting the connection between the blocks in order to remove programming errors.

For this purpose, the authoring sensing unit 154 may be connected to, for example, the authoring supporting unit 160 to transmit and receive information.

The authoring supporting unit 160 receives the authoring information from the authoring sensing unit 154 and provides the additional function to the mash-up authoring unit 150 corresponding to the authoring information.

The additional function provided by the authoring supporting unit 160 may be a function of automatically recommending the block or a function of automatically adjusting the connection between the blocks.

For this purpose, the authoring supporting unit 160 may include a block recommending unit 161 and an automatic block connecting unit 162.

The block recommending unit 161 receives the authoring information, queries the information of the blocks through the block management unit 140, infers candidate blocks that can be replaced with or added to a current template configuration, and provides the result to the mash-up authoring unit 150.

More specifically, for example, the block recommending unit 161 replaces the block configuring the template or searches for the block that can be combined with the block configuring the template through the block management unit 140 based on the property of the block configuring the corresponding template.

Here, in the search method of the block, the block to be matched is searched for based on the number and the data type of input and output parameters of the block configuring the template. In this case, ranking or a usage frequency of recommended blocks may be provided.

After the authoring action is performed, the automatic block connecting unit 162 automatically connects the parameters between the blocks configuring the current template based on the authoring information on the blocks of the template that are replaced, added, and deleted.

Meanwhile, after the parameters between the blocks configuring the template are automatically connected by the automatic block connecting unit 162, an incomplete part is performed such that the user directly adjusts the block of the template and the template through the parameter setting unit 152 and the property setting unit 153, as described above.

The mash-up executing unit 170 executes the mash-up authored by the user and displays the authoring outcome.

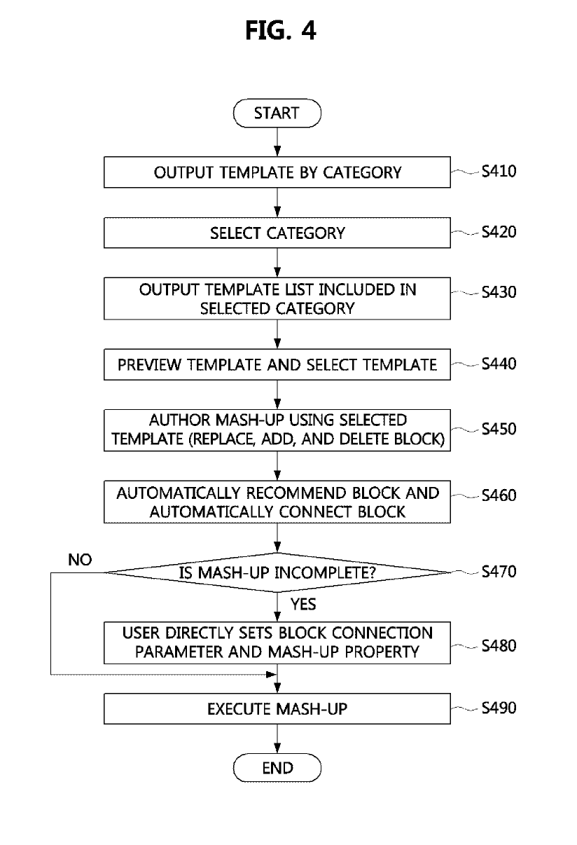

Hereinafter, a mash-up authoring method using the templates according to the embodiment of the invention will be described with reference to FIG. 4.

FIG. 4 is a flowchart illustrating the schematic mash-up authoring method using the templates according to the embodiment of the invention.

First, as illustrated in FIG. 4, in order for the user to easily search for and sort the template corresponding to the mash-up to be authored, a template category in which the templates are distinguished by category and a variety of templates are included is provided (S410).

The user selects the category (S420), and a template list included in the selected category is output (S430).

The preview function of the template is provided to the user, and the user selects the template (S440). That is, the user may use the preview function to view the template in advance and then select a desired template.

The mash-up authoring starts using the selected template (S450). In this case, the mash-up authoring may be easily performed by, for example, replacing, adding, and deleting the default blocks of the template.

The block may be automatically recommended corresponding to the mash-up authoring action and when programming errors between the blocks occur due to, for example, deleting, replacing, and adding of the block, the connection between the blocks may be automatically performed (S460).

After the block is recommended and the block is automatically connected, when the mash-up is completed, the user directly executes the mash-up to check the mash-up authoring outcome (S490).

On the other hand, when the mash-up is not completed, the user may directly set the block connection parameter and the mash-up property (S480). When the mash-up is completed through these operations, the user executes the mash-up to check the mash-up authoring outcome (S490).

As described above, the mash-up authoring device and the method thereof according to the embodiments of the invention use the templates that are provided by category and include the default block suitable for each category. Therefore, it is possible for the user to omit operations of, for example, searching for and selecting the open API necessary for authoring the mash-up, authoring a new block, authoring the workflow and authoring the layout. In addition, complex mash-up authoring operations are omitted so that it is possible to decrease time necessary for authoring the mash-up.

Moreover, it is possible for a general user lacking programming knowledge to easily author the application in the mobile device environment having limited resources.

According to the embodiment of the invention, while a case in which each configuration is illustrated in a different block has been exemplified, each configuration may be provided in one block. For example, each configuration may be provided in, for example, a control unit or a processor, and perform a series of operations.

While the example embodiments of the present invention and their advantages have been described in detail, it should be understood that various changes, substitutions and alterations may be made herein without departing from the scope of the invention as defined by the following claims.

What is claimed is:

1. A mash-up authoring device that creates a mash-up using a plurality of blocks, comprising:
a template generating unit configured to generate a template including at least a first block among the plurality of blocks and provide the template by category;
a mash-up authoring unit configured to provide an authoring space that allows a user to perform mash-up authoring actions of replacing the first block with a second block among the plurality of blocks, adding the second block to the template, and deleting the first block; and
a block recommending unit configured to automatically recommend a third block corresponding to the first block based on parameters of the first block corresponding to the authoring action.

2. The device of claim 1, further comprising an automatic block connecting unit configured to automatically adjust a connection between parameters of the first and second blocks in order to correct errors between the first and second blocks after the mash-up authoring action is performed.

3. The device of claim 1, wherein the mash-up authoring unit includes a parameter setting unit configured to provide a function that allows the user to directly adjust at least one parameter of the first and second blocks in order to complete the mash-up.

4. The device of claim 1, wherein the mash-up authoring unit includes a property setting unit configured to provide a function that allows the user to change a property of the mash-up in order to complete the mash-up.

5. The device of claim 1, wherein the mash-up authoring unit includes an editing unit configured to output a template list of a selected category and provide a preview function of the template selected from the template list.

6. The device of claim 1, wherein the mash-up authoring action is performed by a drag & drop method.

7. The device of claim 1, wherein the block is defined such that an open API is configured as a program module.

8. A mash-up authoring method of creating a mash-up using a plurality of blocks in a mash-up authoring device, comprising:
generating a template including at least a first block among the plurality of blocks and providing the template by category;
providing an authoring space that allows a user to perform mash-up authoring actions of replacing the first block with a second block among the plurality of blocks, adding the second block to the template, and deleting the first block; and
automatically recommending a third block corresponding to the first block based on parameters of the first block corresponding to the authoring action.

9. The method of claim 8, further comprising automatically adjusting a connection between parameters of the first and second blocks in order to correct errors between the first and second blocks after the mash-up authoring action is performed.

10. The method of claim 8, wherein the providing of the authoring space includes providing a function that allows the user to directly adjust at least one parameter of the first and second blocks in order to complete the mash-up.

11. The method of claim 8, wherein the providing of the authoring space includes providing a function that allows the user to change a property of the mash-up in order to complete the mash-up.

12. The method of claim 8, wherein the providing of the authoring space includes outputting a template list of a selected category and providing a preview function of the template selected from the template list.

13. The method of claim 8, wherein the mash-up authoring action is performed by a drag & drop method.

14. The method of claim 8, wherein the block is defined such that an open API is configured as a program module.
